(19) United States
(12) Patent Application Publication
(10) Pub. No.: US 2014/0019317 A1
(43) Pub. Date: Jan. 16, 2014

(54) Transaction managing system

(71) Applicants: Wenceslao Casares, Woodside, CA (US); Federico H. Murrone, Buenos Aires (AR)

(72) Inventors: Wenceslao Casares, Woodside, CA (US); Federico H. Murrone, Buenos Aires (AR)

(73) Assignee: LEMON, INC., Palo Alto, CA (US)

(21) Appl. No.: 13/830,968

(22) Filed: Mar. 14, 2013

Related U.S. Application Data
(60) Provisional application No. 61/655,757, filed on Jun. 5, 2012.
(60) Provisional application No. 61/620,943, filed on Apr. 5, 2012.

(51) Int. Cl. G06Q 40/00

(52) U.S. Cl. CPC G06Q 40/10
USPC 705/30

(57) ABSTRACT

Present example embodiments relate generally to systems, methods, devices, and computer-readable media for capturing details of a transaction, extracting details of the transaction, categorizing details of the transaction, storing details of the transaction, and creating customizable reports of the details of the transaction in numerical or graphical form, and advising on savings for past and/or future transactions.

### CROSS-REFERENCE TO RELATED APPLICATIONS

The present application claims priority to U.S. Provisional Application No. 61/655,757 filed on Jun. 5, 2012, entitled “Transaction management system,” and U.S. Provisional Application No. 61/620,943, filed on Apr. 5, 2012, entitled “Transaction managing system,” both of which are incorporated herein by reference in their entirety.

### TECHNICAL FIELD

The present disclosure relates generally to systems, methods and devices for storing, tracking, and reporting of transactions.

### BACKGROUND

In a retail transaction, a consumer effects payment to a merchant (or retailer or seller) in exchange for goods and/or services. Typical retail transactions may include conventional brick-and-mortar transactions, as well as internet, telephonic, email, interactive TV, NFC-based, or other analog, digital, wired and/or wireless forms of transactions.

To complete a transaction, a merchant typically provides a consumer with a transaction record, such as a paper receipt, an electronic receipt, other proof of payment, or the like (hereinafter “receipt,”) and also retains one or more copies of the receipt.

Electronic receipts may include emails containing the receipt in the body of the email and/or emails containing file attachments (ex. PDF, Word, Excel, JPG, TIFF, etc.). Electronic receipts may also be in the form of MMS/SMS messages, instant messages, application-specific messages, and other forms of digitally communicable receipts.

Paper receipts are often printed in duplicates, wherein one or more receipts are provided to the consumer and one or more other receipts are retained by the merchant.

Receipts are typically used by merchants to record and/or verify sales transactions at the end of a given period, such as a shift or a day. Receipts may also be used in inventory management and theft prevention. For example, a retail store may have employees check whether or not patrons within or leaving their premise have receipts for item(s) in their possession. Receipts are also used in reversing or correcting transactions, such as in a refund transaction, to ascertain whether goods/services were indeed previously purchased from the merchant.

Receipts are often used by consumers to manage their personal and/or business finances (hereinafter “manage finances.”) For example, consumers use receipts for tracking and reviewing their spending, balancing their budgets (one or more accounts, such as bank accounts, credit accounts, loyalty accounts, merchant accounts, etc.), submitting reimbursement requests for business expenses, identifying and qualifying taxable reductions, managing warranty claims and making price adjustment requests. It is recognized herein that consumers often encounter problems and/or inaccuracies in managing their finances, particularly in regard to reflecting their true or actual net spending. For example, consumers often leave their paper receipts in several places, including their pockets, wallets, purses, sports bags, briefcases, laptop bags, suitcases, home/office drawers, cars, etc. Misplaced, lost and/or forgotten receipts are often not considered when consumers manage their finances.

It is also recognized herein that receipts are not always available to the consumer. For example, a merchant may be incapable of providing a receipt due to a malfunctioning cash register/computer system or one that is out of paper. As another example, the merchant may simply forget to provide the receipt or the consumer may simply forget to obtain the receipt. As another example, the consumer may simply lose, damage, or destroy the receipt. As another example, the receipt may be in possession of another person, such as in transactions wherein one receipt is issued for a group. In yet another example, the seller may be a friend or other private merchant (ex. garage sale, classified ad) who are unable to issue a receipt. Such transactions are often not considered when consumers manage their finances.

It is also recognized herein that physical and/or electronic possession of two or more receipts for the same transaction often causes inaccuracies when consumers manage their finances. As an example, many online merchants will first issue an email receipt to the consumer, followed by a paper receipt included with the order delivery. As another example, many online merchant may provide shipping or other order updates, which may contain the original receipt information. In such situations, consumers may unintentionally consider the several email receipts and/or the paper receipt as more than one transaction when managing their finances, thereby causing their apparent spending to be greater than their actual spending.

Transactions comprising one or more cash-equivalent and/or non-cash equivalent transactions are also recognized herein to cause problems and/or inaccuracies in managing consumer finances. Hereinafter, “cash-equivalents” will broadly refer to those instruments that have a direct or immediate (causal) net monetary consequence to the consumer. Examples of cash-equivalents may include cash, secured or unsecured credit or debit (ex. Visa, MasterCard, American Express, PayPal, electronic wallets, loan, deferred payment plans, merchant credit notes, gift cards, etc.), and other instruments that are readily convertible to cash. Oftentimes, a consumer will possess one or more consumer accounts associated with cash-equivalents (such as one or more checking or savings bank accounts in one or more currencies and/or one or more credit or debit card accounts issued by one or more financial institutions), and each account may also be associated with and/or provide loyalty accounts, such as loyalty points, air miles, etc. In contrast, “non-cash equivalents” will broadly refer to those instruments that have an indirect monetary or non-monetary consequence to the consumer. Examples of non-cash equivalents may include air miles, loyalty or reward points, redeemable coupons, gifts, cash withdrawals, and the like.

It is also recognized herein that certain receipts may not reflect net cash-equivalent or non-cash equivalent spending by the consumer. Examples include situations wherein purchased item(s) in a receipt were later refunded, a receipt was later reimbursed by an employer, a receipt was partially or wholly paid by others (ex. one dinner receipt for multiple diners at the table), multiple payment methods for multiple part of the charge (ex. gift cards, credit or debit cards and/or cash for the main purchase amount, tax and/or tip), and/or a receipt includes a non-spending transaction (or a net non-cash equivalent transaction), such as a cashback transaction. Cashback transactions, and equivalents thereof, are examples of non-spending transactions that are offered by some merchants to allow consumers to withdraw cash (or equivalents) using their debit/credit card, the amounts of which are added as a non-taxed line item in the receipt. It is recognized herein that such non-spending transactions of a receipt often skew or artificially inflate consumer finances, and are often not properly considered when consumers manage their finances. For example, after a consumer transacts to purchase a $10 item with applicable taxes of 8% and requests cashback of $80 recorded in the same receipt, the consumer may proceed to spend $50 of the $80 cashback for another separate transaction. Conventional methods and applications typically consider the two transaction amounts to be $90.80 ($10 purchase+8% taxes on the purchase+$80) and $50, for a total of $140.80. The actual cash-equivalent spending amounts by the consumer, however, should properly be recorded as $10.80 and $50, for a total of $60.80.

It is also recognized herein that receipts in a foreign currency are often overlooked by a consumer when managing their finances. In this regard, conventional methods and applications often inaccurately record foreign currency transactions, such as considering the numeric amount (in foreign currency) instead of the appropriate converted amount (and appropriate currency) used by the consumer in managing their finances, using an incorrect foreign exchange rate, etc. Prudent consumers will often be required to isolate such foreign receipts and perform proper foreign currency conversion and/or foreign language translation before managing their transactions.

Furthermore, it is recognized herein that a vast majority of consumers are also unable, unwilling and/or unaware of how to realize monetary savings for past and/or future transactions. This is particularly true since most of these consumers will either not know where or how to efficiently search for better prices of purchased items and/or items they may want to purchase.

Recently, expense tracking applications have been introduced in the form of mobile applications and desktop/laptop applications. While these expense tracking applications find use for those who are diligent in keying in details of each transaction, they provide little help in solving the above recognized problems. For instance, conventional expense tracking applications are incapable of providing consumers with reports of their cash-equivalent and non-cash equivalent transactions, and therefore fail to reflect, among other things, their true or actual net spending.

### SUMMARY

In considering the above examples, it is recognized herein that the above problems and inaccuracies found in conventional methods and applications can be readily solved using example embodiments.

Present example embodiments relate generally to devices, systems, methods and computer readable medium for performing transaction management of a plurality of transaction receipts.

In an exemplary embodiment, a computing device for transaction management of a plurality of transaction receipts is operable to communicate with at least one network-accessible computing device. The computing device comprises a display screen; a capturing device operable to capture a digital representation of at least a part of a transaction receipt; a storage medium operable to store digital representations captured by the capturing device; and a processor. The processor is operable to communicate with the capturing device to perform capturing of the digital representation; communicate with the storage medium to store the captured digital representation; communicate with at least one network-accessible computing device to facilitate processing of the digital representation; and communicate with the display screen to display at least one cash-equivalent transaction report of one or more processed digital representations.

In another exemplary embodiment, a computing device for transaction management of a plurality of transaction receipts is operable to communicate with at least one network-accessible computing device. The computing device is operable to capture a digital representation of at least a part of a transaction receipt, extract information from the captured digital representation, analyze and categorize the extracted information, and display at least one cash-equivalent transaction report based on the categorized information.

In another exemplary embodiment, a network-accessible computing device is operable to facilitate transaction management of a plurality of transaction receipts and communicate with a consumer computing device. The network-accessible computing device comprises a capturing device operable to capture a digital representation of at least a part of a transaction receipt; a storage medium operable to store digital representations captured by the capturing device; and a processor. The processor is operable to process the digital representation captured from the capturing device; process a digital representation of a transaction captured from the consumer computing device; and communicate with the consumer computing device to facilitate displaying of at least one cash-equivalent transaction report of one or more processed digital representations.

In another exemplary embodiment, a network-accessible computing device for transaction management of a plurality of transaction receipts is operable to communicate with a consumer computing device. The network-accessible computing device is operable to capture a digital representation of at least a part of a transaction receipt; extract information from the captured digital representation; analyze and categorize the extracted information; and selectively communicate one or more categorized information of one or more processed digital representations to the consumer computing device for use in displaying cash-equivalent transaction reports.

In yet another exemplary embodiment, a system is operable to perform transaction management of a plurality of transaction receipts. The system comprises a consumer computing device and an administrator computing device. The consumer computing device comprises a consumer display screen; a consumer capturing device operable to capture a digital representation of at least a part of a transaction receipt; a consumer storage medium operable to store digital representations captured by the consumer capturing device; and a consumer processor operable to communicate with the consumer capturing device to perform capturing of the digital representation. The consumer computing device is operable to communicate with the consumer storage medium to store captured digital representations; facilitate processing of the digital representation; and communicate with the consumer display screen to display at least one cash-equivalent transaction report of one or more processed digital representations. The administrator computing device comprises an administrator capturing device operable to capture a digital representation of at least a part of an electronic transaction receipt; an administrator storage medium operable to store digital representations captured by the administrator capturing device and digital representations captured by the consumer capturing device; and an administrator processor operable to process one or more digital representations of one or more transactions captured from the administrator capturing device and the consumer capturing device. The administrator capturing device is operable to communicate with the consumer computing device to facilitate displaying of at least one cash-equivalent transaction report of one or more processed digital representations. The consumer computing device facilitates processing and the administrator computing device processes one or more digital representations captured by the consumer capturing device when the consumer computing device communicates the digital representation to the administrator computing device.

### BRIEF DESCRIPTION OF THE DRAWINGS

For a more complete understanding of the present disclosure and its advantages, reference is now made to the following description taken in conjunction with the accompanying drawings, in which like reference numbers indicate like features, and:

FIG. 1 is an illustration of an example embodiment;

FIG. 2 is an illustration of an example cloud computing-based embodiment;

FIG. 3 is a high level illustration of an example embodiment;

FIG. 4 is an illustration of an example embodiment for capturing a transaction;

FIG. 5 is an illustration of an example embodiment for extracting and categorizing information from a captured transaction;

FIG. 6 is an illustration of an example embodiment for reporting of transactions;

FIG. 7 is an example screen shot displayable on a consumer computing device;

FIG. 8 is another example screen shot displayable on a consumer computing device;

FIG. 9 is an example screen shot of saved or captured consumer-specific accounts displayable on a consumer computing device;

FIG. 10 is an example screen shot displayable on a consumer computing device to allow a consumer to store or capture information of consumer-specific accounts, such as a Visa credit card;

FIG. 11 is an example screen shot displayable on a consumer computing device to allow a consumer to prevent unauthorized persons from accessing example embodiments of the consumer computing device;

FIG. 12 is an example screen shot displayable on a consumer computing device after a successful login;

FIG. 13 is an example screen shot displayable on a consumer computing device depicting an example transaction summary captured using example embodiments; and

FIG. 14 is an example screen shot displayable on a consumer computing device depicting an example captured transaction summary.

Although similar reference numbers may be used to refer to similar elements for convenience, it can be appreciated that each of the various example embodiments may be considered to be distinct variations.

### DETAILED DESCRIPTION

The present embodiments will now be described hereinafter with reference to the accompanying drawings, which form a part hereof, and which illustrate example embodiments which may be practiced. As used in the disclosures and the appended claims, the terms “embodiment” and “example embodiment” do not necessarily refer to a single embodiment, although it may, and various example embodiments may be readily combined and interchanged, without departing from the scope or spirit of the present embodiments. Furthermore, the terminology as used herein are for the purpose of describing example embodiments only and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

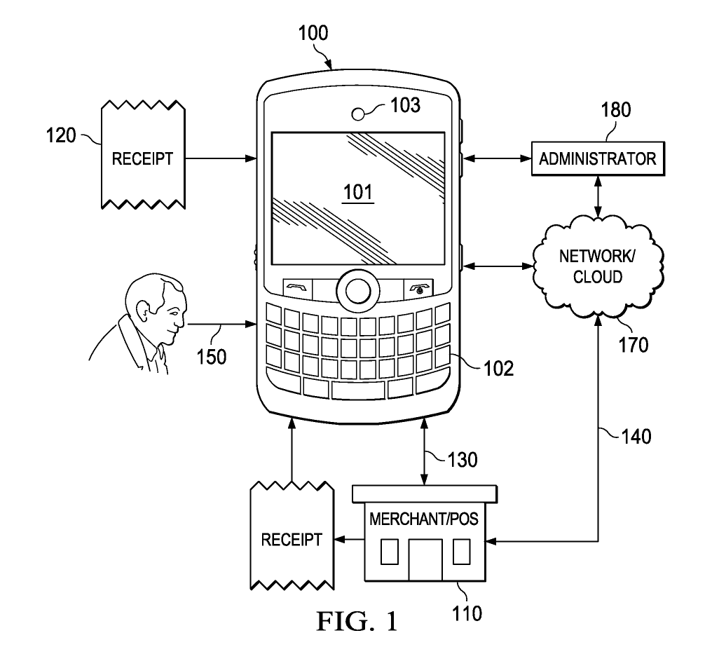

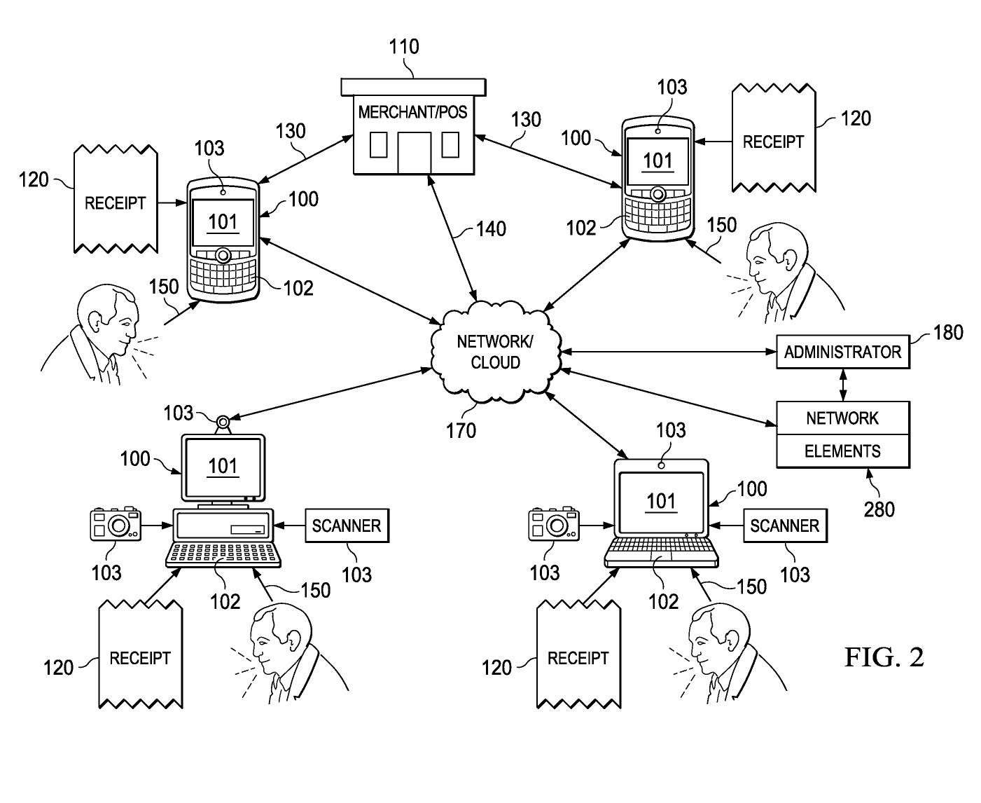

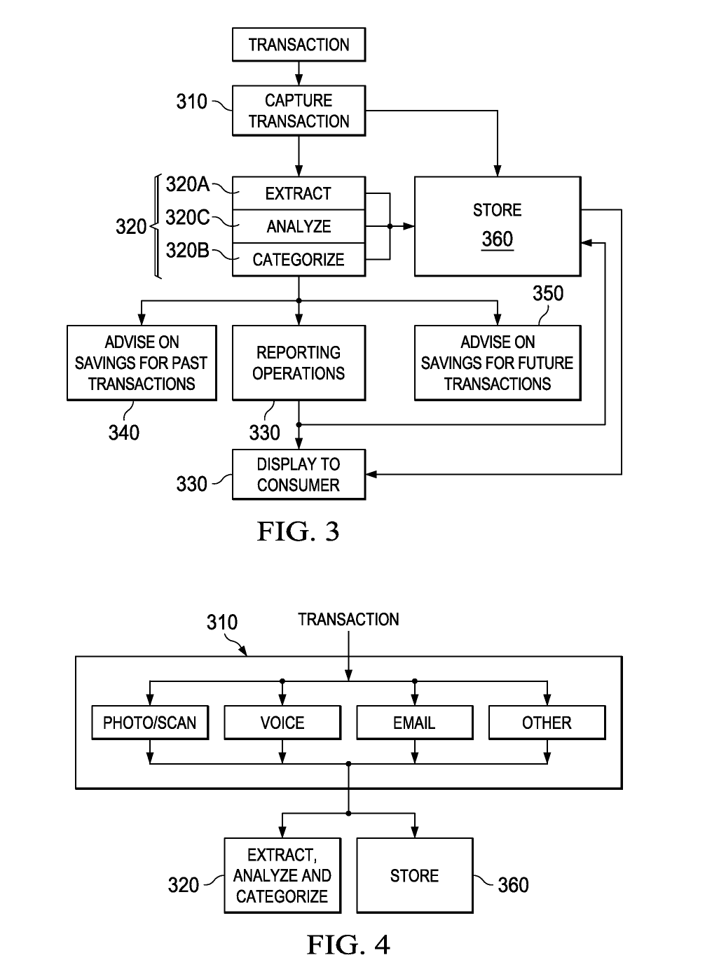

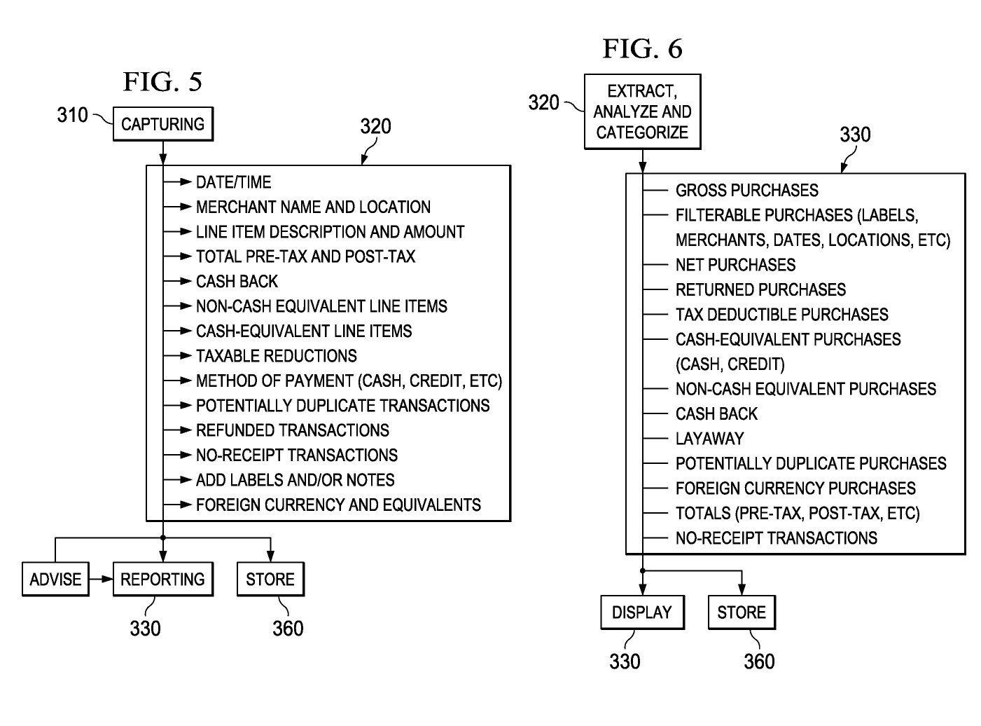

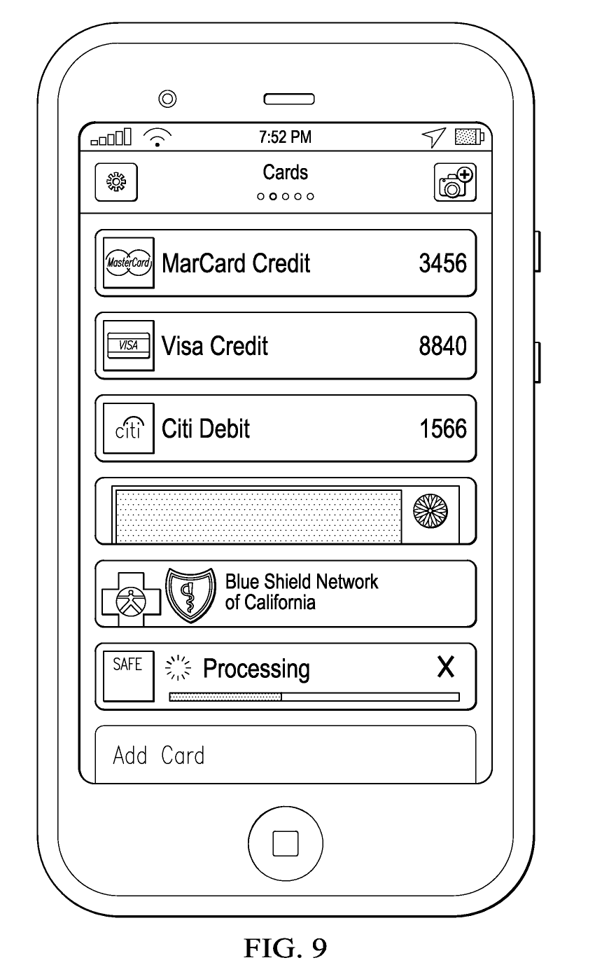

FIGS. 1 and 2 depict example embodiments of a transaction management device 100 for use in, among other things, managing a plurality of cash-equivalent and/or non-cash equivalent transactions, including non-spending transactions, for one or more consumer accounts while also enabling users to realize spending reductions for past and/or future transactions. As illustrated in FIGS. 3-6, example embodiments are operable to do so by example embodiments of a process 300 of capturing 310 (or saving or storing) a plurality of types of transactions and consumer-specific information, extracting 320A details of each captured transaction from receipts and/or consumer-specific accounts, analyzing 320C and categorizing 320B each extracted detail, reporting 330, either automatically or through user request and customization, and advising 340, 350 and suggesting on how to realize monetary benefits and/or savings for past and/or future transactions. In doing so, the administrator is also enabled to obtain and analyze a variety of consumer spending information, including obtaining information on the effectiveness of advising and suggesting specific products and/or services based on, among other things, consumer spending habits, preferred merchants, price ranges, brands, purchase dates and occasions, and preferred consumer account usage (specific credit cards, debit cards, bank accounts, loyalty programs, etc.), etc. In respect to advising and suggesting, the administrator is enabled to determine, and subsequently improve (if necessary), the effectiveness of advertising by assessing the advised or suggested products and/or services with actual captured transactions made by the consumer. Example embodiments are operable to perform said processing 300 for all types/forms of transactions, including personal and/or business expenses recorded physically or electronically, so as to identify, among other things, cash-equivalent payments and specific types of cash-equivalent payments; non-cash equivalent payments and specific types of non-cash equivalent payments; potentially conflicting transactions (such as duplicate receipts); refunded or corrected transactions; transactions without receipts; foreign currency and/or language transactions; business transactions eligible for reimbursements; warranty claims; price adjustments; and potential taxable deductions. Example embodiments, such as the example screen shots illustrated in FIGS. 9, 10, and 12, are also operable to capture consumer-specific information, including one or more consumer credit card accounts, debit card/bank accounts, and loyalty accounts (including associations with specific other accounts, such as credit or debit card accounts), and the associated secure online login information for each account. In doing so, example embodiments herein are operable to securely access through a network, such as the internet, the one or more stored consumer-specific accounts so as to, among other things, confirm captured transactions, identify discrepancies, identify missing or uncaptured transactions for the consumer, provide advice and/or suggestions on products and/or services, etc., and update reporting 330 to the consumer. It is to be understood herein that consumers are also enabled to provide labels and/or names to specific consumer accounts so as to enable convenient access and recording of information and reports for each account at a future occasion.

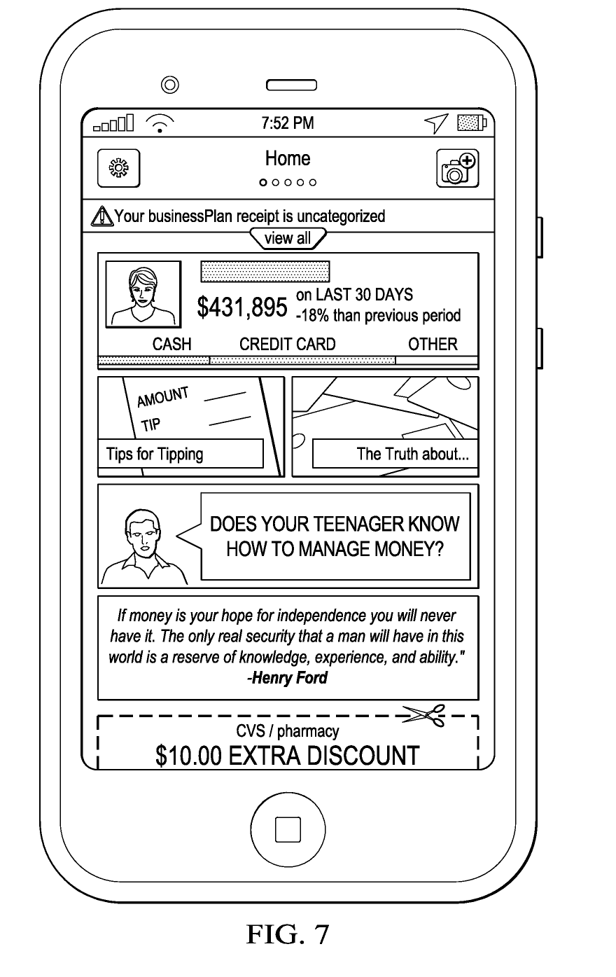

As depicted in FIGS. 1 and 2, example embodiments comprise a consumer computing device 100 having instructions stored therein for facilitating and/or performing transaction management in cooperation with example embodiments of one or more administrator network-accessible computing devices 180, 280 and third-party network-accessible systems (not shown). Third-party network-accessible systems may include, for example, those for accessing debit/bank accounts, credit card accounts, loyalty accounts, merchants, etc. Example embodiments of the consumer computing device 100 may be in the form of a mobile smart phone, a computer, a tablet, an e-book, or the like. Example embodiments of the administrator network-accessible computing device 180, 280 may comprise those computing devices for use in cloud computing, client-server based computing, and the like. The consumer computing device 100 is operable to display to the consumer a plurality of different page views, including a home page, each of which may be customizable in example embodiments so as to display, among other things, a plurality of information including totals and balances, advice and suggestions, recent and/or historic transactions, recent activities, warnings (such as low balance, inconsistent transactions, missing transactions, etc.), reminders (such as upcoming payments, etc.), etc. Examples of screen shots of the home page are illustrated in FIGS. 7 and 8, and FIG. 11 depicts an example secure login page for accessing example embodiments of the transaction management system on a consumer computing device 100.

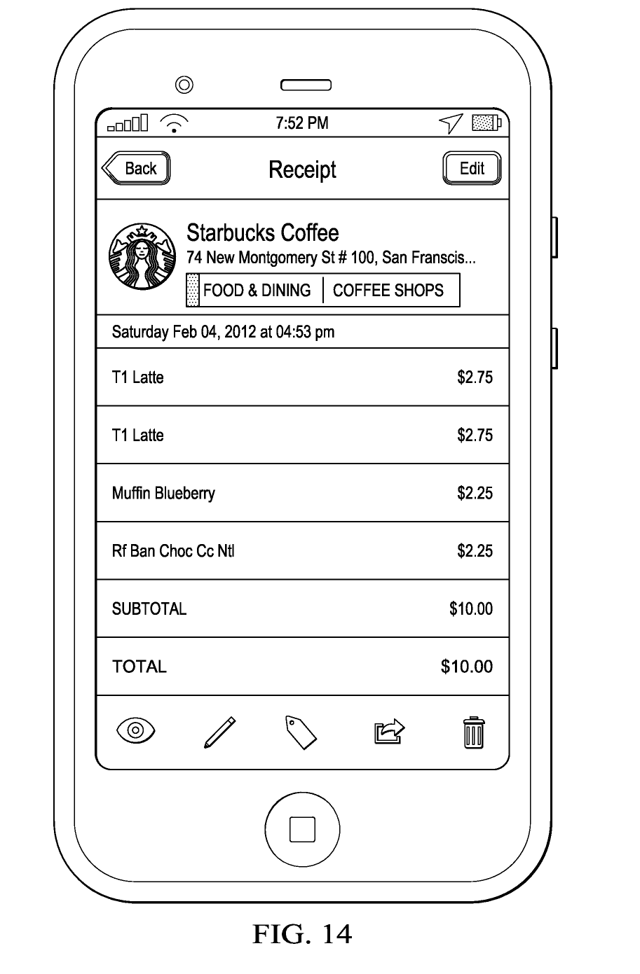

A consumer engaged in a transaction may be provided with one or more transaction summaries (“receipts”), such as a physical receipt 120, an electronic receipt 130, 140, 150, and/or a summary of the transaction in other ways, such as on a display (such as a screen) or by sound (such as orally or through a speaker). An example screen shot of a captured or stored receipt is depicted in FIG. 14. Physical receipts 120 include paper receipts 120. Today, physical receipts 120 are still by far the most common form of receipt issued by merchants 110. Electronic receipts 130, 140, 150 are particularly prevalent in e-commerce transactions and are becoming increasingly popular for traditional offline merchants. Electronic receipts 130, 140, 150 may be in the form of an email message, other forms of electronic messaging, a software file (ex. PDF, Word, Excel, audio and/or video format files, etc.) attached to an electronic message, instant messages, or the like, and may be provided to the consumer, directly and/or indirectly, using a variety of wired and/or wireless technologies, including email 140, the internet 140, Bluetooth 130, SMS messaging 140, RFID communications 130, 140, NFC 130, 140, Wi-Fi 140, or the like.

Example embodiments of devices, systems and computer readable media, and processes performable by example embodiments, including capturing, extracting, analyzing, categorizing, reporting and advising/suggesting, will now be explained with reference to the accompanying drawings.

1. Capturing.

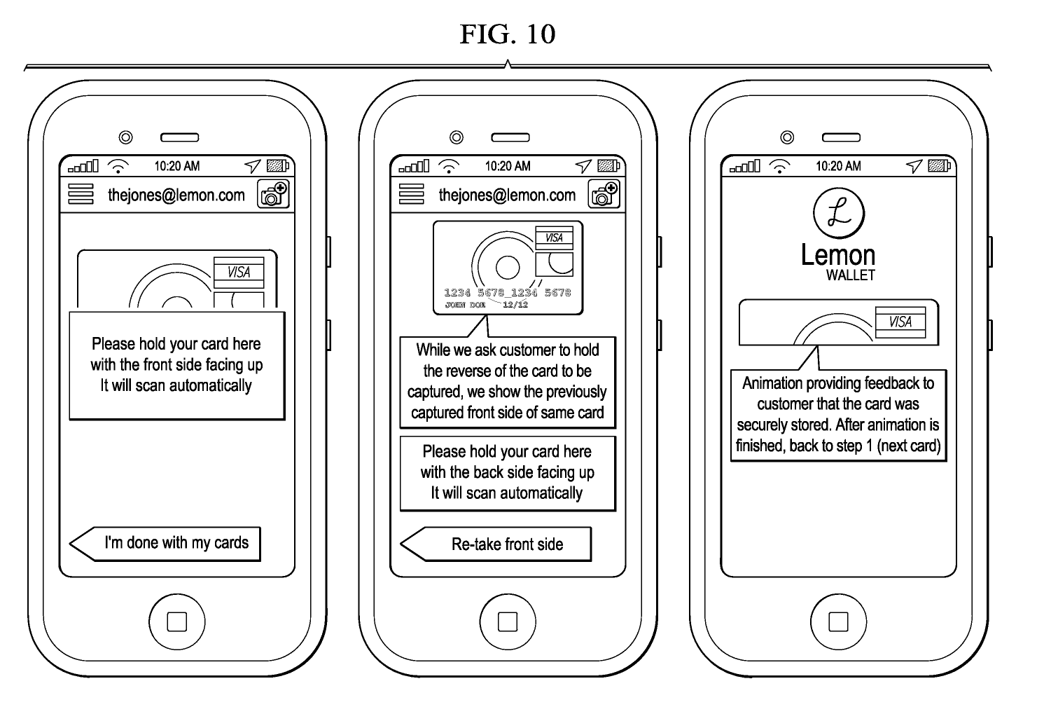

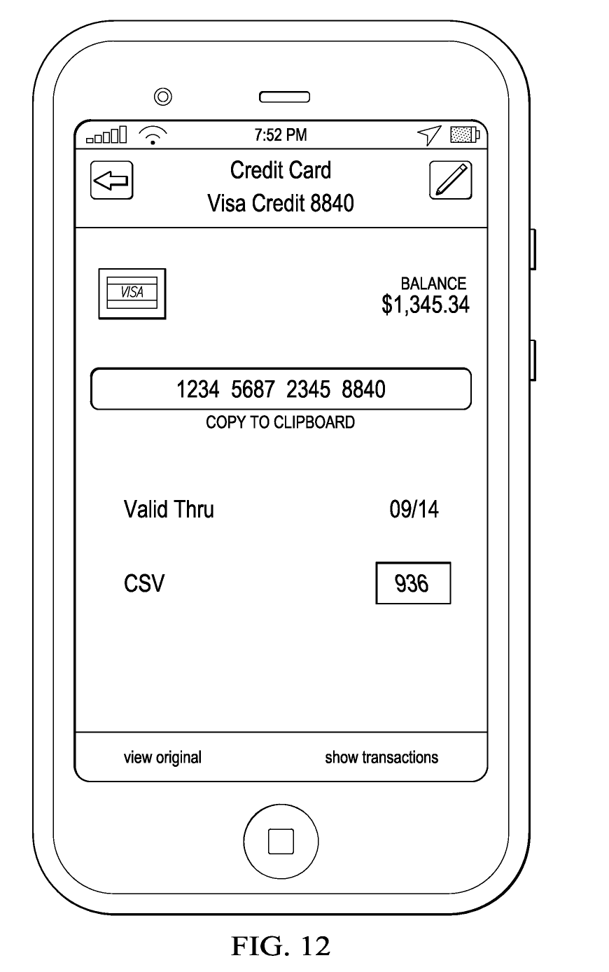

Example embodiments are operable to perform capturing 310 (or saving or storing) of transactions recorded in physical receipts 120, transactions recorded in electronic receipts 130, 140, 150, transactions without receipts 150, and the like. Example embodiments are also operable to capture consumer-specific account information provided by the consumer, such as credit card accounts, debit card/bank accounts, loyalty accounts, and the associated secure online login information for each consumer-specific account. Once stored, example embodiments are operable to capture, and subsequently extract, analyze, categorize, suggest/advise, and/or report on, transactions pertaining to specific consumer accounts from, among other things, transaction summaries (such as receipts). FIG. 9 illustrates an example screen shot depicting stored and/or captured consumer-specific accounts, such as credit cards, debit cards, loyalty cards, gift cards, etc.; FIG. 10 illustrates an example screen shot depicting an example method of capturing and/or storing consumer-specific information, such as those having a physical card (ex. credit card, debit card, gift card, credit note, ID cards, health/insurance cards, business cards, etc.); and FIG. 12 illustrates an example screen shot depicting a summary of a consumer-specific account after a successful secure online login to the consumer-specific account.

Physical receipts 120, such as paper receipts 120, are capturable as digital representations. In an example embodiment, a physical receipt 120 is capturable as a digital representation by taking a photograph and/or performing a scan (such as scanning a printed QR code, bar code, or the like) of the physical receipt 120 using example embodiments of a capturing device 103 attached to or integrated with a consumer computing device 100. Physical receipts 120 may also be capturable as an audio and/or video file using example embodiments of a capturing device 103. In respect to a scan and/or code, an example embodiment of a merchant computing device 110, such as a POS device 110, is operable to generate a unique code, or the like, for each receipt, which enables a consumer computing device 100 to scan and perform extracting of information from the receipt 120, 130, 140.

Example embodiments enable a consumer to capture and revisit a digital representation of a receipt 120, 130, 140, 150 in the future, such as the digital representation depicted in FIG. 14. Digital representations of a receipt 120, 130, 140, 150 are used in example embodiments for extracting 320A, analyzing 320B, categorizing 320C, reporting 330 and/or advising/suggesting 340, 350 operations. It is to be understood herein that digital representations of a receipt 120, 130, 140, 150 may be saved locally on the consumer computing device 100 and/or remotely on one or more administrator network-accessible computing devices 180, 280, such as those for use in cloud computing, another computing device of the consumer, etc. For example, digital representations may be storable on a consumer mobile device 100, such as a smart phone or tablet computer; on a consumer remote storage facility 180, 280, such as a cloud storage service; on a consumer computer 100; and/or on an administrator remote storage facility 180, 280, such as those for use in cloud computing.

Physical 120 and/or electronic 130, 140, 150 receipts are capturable by example embodiments in other ways, including use of voice dictation 150, video capture, and/or character entry 102 by the consumer and/or merchant. Hereinafter, a voice recording of details of a transaction or receipt will be referred to as a “voice receipt.” Voice dictation 150, audio and/or video capture, and/or character entries 102 may be used in example embodiments to capture details of transactions wherein the consumer may not be in possession of a receipt. For example, a transaction with a friend is capturable in the form of a voice receipt 150, video capture or character entry 102 by recording some or all details of the transaction, including the date, merchant (friend) name, widget description, price paid, payment method, currency, and/or the like. In example embodiments, one or more digital representations (such as a digital photograph) of the one or more acquired products and/or services is also capturable, and such digital representation(s) may be associated with the corresponding captured transaction so as to enable the consumer to, among other things, revisit the acquired product/service corresponding to the transaction at a future occasion.

Example embodiments are operable to capture 310 electronic receipts, such as those contained in email messages 140 (“email receipts,”) or the like. Hereinafter, example embodiments operable to manage email receipts 140 will be described, although the descriptions will also be equally applicable to example embodiments operable to process electronic receipts in other forms, such as Bluetooth receipts 130, application-specific receipts 130, 140, SMS receipts 140, RFID-based receipts 130, 140, NFC-based receipts 130, 140, and receipts captured by voice 150 and character input.

After receiving an email receipt 140, example embodiments are operable to capture 310 the email receipt 140 locally on the consumer computing device 100 and/or remotely, such as on an administrator network-accessible computing device 180, 280, including those for use in cloud computing 170. Example embodiments are operable to receive the email receipt 140 in various ways, such as from an email receipt forwarded by the consumer 100 to a dedicated email address and/or from an email receipt sent directly by a merchant 110 to a dedicated email address. Example embodiments are also operable to receive consumer electronic messages, and appropriately manage electronic receipts 130, 140 for further processing.

Receipts 120, 130, 140, 150 are capturable in example embodiments comprising a consumer computing device 100, such as a mobile smart phone or tablet computer. For example, digital representations of receipts are locally capturable 310 by an attached or integrated image or video capturing device 103, such as a digital camera 103, of a computing device 100. As another example, digital representations of voice receipts 150 are locally capturable 310 by an attached or integrated audio capturing device, such as a microphone, of a computing device 100. Captured digital representations of receipts are then accessible by the computing device 100 and/or other network-accessible devices 180, 280 for performing other operations, including analyzing 320C, categorizing 320B, reporting 330 and/or advising/suggesting 340, 350.

Receipts 120, 130, 140, 150 are also capturable remotely by example embodiments comprising one or more administrator network-accessible computing devices 180, 280, including those for use in cloud computing. For example, digital representations of email receipts 140 are remotely capturable by a computing device 180, 280 capable of receiving, filtering and manipulating contents of emails, and the like. As another example, digital representations of SMS receipts 140 are remotely capturable by a computing device 180, 280 capable of receiving, filtering and manipulating contents of SMS messages, and the like. Captured digital representations of receipts are then accessible by one or more network-accessible devices 180, 280 and/or the consumer computing device 100 for performing other functions, including analyzing 320C, categorizing 320B, reporting 330 and/or advising/suggesting 340, 350.

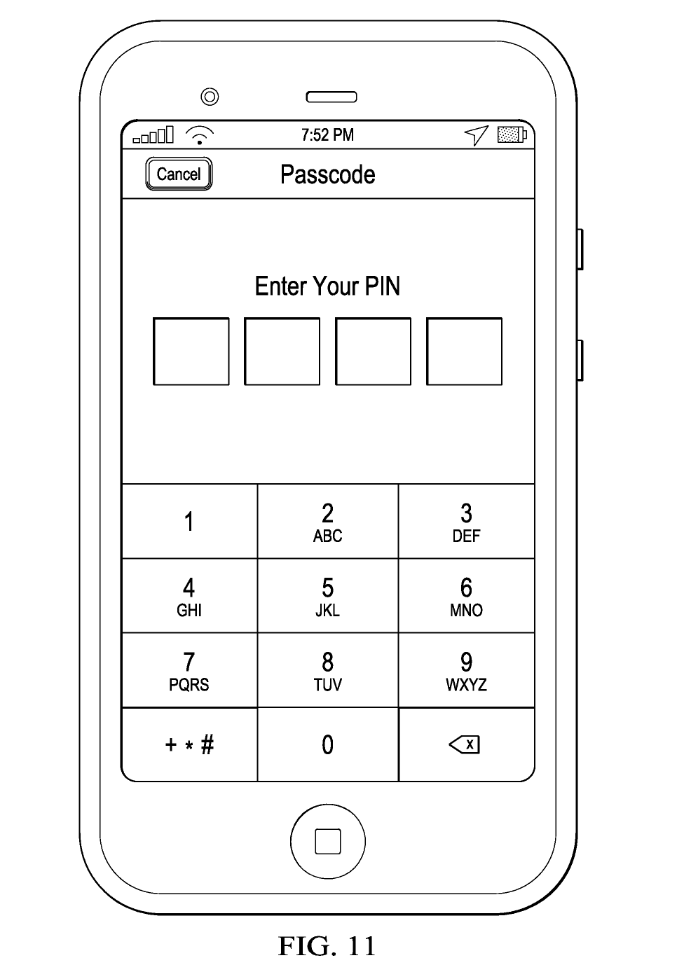

In example embodiments, consumer-specific account information can be captured in a plurality of ways, including enabling the consumer to identify and save the specific account information (ex. searching through a list, manual entry, etc.), capturing a digital representation of the consumer-specific information (such as in the example illustrated in FIG. 10), establishing and/or maintaining a secure online connection to a consumer-specific account (such as the login screen shot in FIG. 11 and the account screen shot in FIG. 12), and associated secure online login information for the consumer-specific account. For example, the consumer may identify a specific Visa credit card of a specific financial institution and its associated secure online login information for accessing the specific Visa credit card account. In doing so, the consumer may perform character entry, capturing and/or storing of a digital representation of the Visa credit card (such as a digital picture, video, and/or audio dictation as illustrated in the example of FIG. 10), linking to the account (ex. with a participating institution, as illustrated in the example of FIG. 12), etc.

In example embodiments, after the consumer completes the capturing of the consumer-specific account, the consumer computing device is operable to enable the consumer to affect transactions with or without use of a physical representation of the account. For example, a consumer computing device having stored therein a digital representation of a Visa credit card of the consumer may complete a purchase transaction with a merchant (such as through a merchant store or the Internet) using the stored information by one or more of a plurality of ways, such as through use of NFC technology, scanning the display screen of the consumer computing device (such as barcode, QR code, etc.), secure wireless communication (such as RFID technology, etc.), messaging (such as Bluetooth, SMS, etc.), and the like. In this regard, the consumer is enabled to effect transactions without necessarily presenting a physical representation of their accounts (ex. a credit card). In example embodiments, stored consumer information, such as an ID card (ex. a drivers license), may also be used to confirm identity when affecting a transaction, such as one at a merchant store. Example embodiments are also operable to securely access the internet (such as an internet browser, a mobile application, or the like) and/or securely communicate with an application capable of accessing the internet (such as through an Internet browser, a mobile application, or the like) so as to enable the consumer to quickly and securely affect an online transaction without having to manually enter for each transaction one or more consumer account information, such as a credit card number, expiry date, security codes (such as CVV or Card Verification Value), billing address, shipping address, card holder name, etc. In a similar manner as described above, some online transactions may also be affected by providing and/or confirming the identity of the consumer through use of stored consumer information, such as an ID card.

It is to be understood herein that the captured digital representations may be storable on one or more connected 100 and/or remote storage media 180, 280, or the like. The one or more storage media (database) may reside locally on the consumer computing device 100 and/or remotely on a network-accessible computing device 180, 280, including those for use in cloud computing.

2. Extracting.

Example embodiments are operable to perform extracting 320A of the captured digital representations of receipts. In performing extracting 320A, example embodiments identify and convert captured digital representations into recognizable, meaningful and manipulable characters, including letters, symbols, numbers and/or codes (hereinafter “characters.”) Example embodiments are also operable to identify and translate foreign language receipts into the default language of the consumer, and/or convert the foreign currency amounts in the receipt to equivalent amounts corresponding to the default or preferred currency of the consumer. In doing so, example embodiments are operable to obtain relevant foreign exchange rates on particular dates, such as through use of the internet 170, through dedicated secure communications with one or more financial institutions 170, such as the above-described secure login (see example in FIG. 11) and access to the consumers' credit card account (see example in FIG. 12), and/or through user input 102.

Characters are extractable by example embodiments comprising a consumer computing device 100, such as a mobile smart phone 100. For example, characters are locally extractable from digital representations of receipts 120, 130, 140, 150 that were locally captured by a consumer computing device 100. As another example, characters are locally extractable from digital representations of electronic receipts 130, 140, 150 that were locally captured by a consumer computing device 100. Extracted characters are then accessible by the computing device 100 and/or one or more network-accessible computing devices 180, 280 for performing other functions, including categorizing 320B, reporting 330 and advising 340, 350.

Characters are also extractable by example embodiments comprising one or more administrator network-accessible computing devices 180, 280, including those for use in cloud computing. For example, characters are remotely extractable from digital representations of email receipts 140 that were remotely captured by one or more computing devices 180, 280 capable of receiving and manipulating contents of emails. As another example, characters are remotely extractable from digital representations of SMS receipts 140 that were remotely captured by one or more computing devices 180, 280 capable of receiving and manipulating contents of SMS messages. Extracted characters are then accessible by one or more network-accessible devices 180, 280 and/or the consumer computing device 100 for performing other functions, including categorizing 320B, reporting 330 and advising 340, 350. In example embodiments, credit card information and/or other consumer-specific account information displayed on the receipt are also capturable and extractable for use in the analyzing step. It is to be understood that, for receipts which only display partial information, such as only the last 4 digits of the credit card number, example embodiments will be operable to appropriately match and identify the captured numbers with the consumers' saved account numbers (ex. the corresponding last four digits of a credit card).

It is to be understood herein that the extracted characters may be storable on one or more connected 100 and/or remote storage media 180, 280, or the like. The one or more storage media may reside locally on the consumer computing device 100 and/or remotely on a network-accessible computing device 180, 280, including those for use in cloud computing.

3. Analyzing.

Example embodiments of consumer computing devices 100 and/or administrator network-accessible computing devices 180 are operable to perform and/or facilitate performing the analysis 320C of the captured and/or extracted characters. Analysis 320C is performable based on a plurality of considerations, including information extracted from the receipt, knowledge of past and/or present merchant practices, consumer input, and/or administrator input.

Examples of information contained in receipts include: the placement and context of the characters in relation to other characters in the receipt; line item descriptions and amounts; identification numbers, such as receipt numbers, order numbers, delivery numbers, and other referencable numbers; the type of receipt (ex. proof of payment, proof of deposit, proof of refund and/or exchange, proof of correction, proof of delivery, etc.); the amount of taxes paid in the receipt; codes and/or symbols; credit card numbers, either in full or in part; and information about the merchant, including the merchant name, type of business, geographical location (address), telephone, website, email address, etc.

Knowledge of past and/or present merchant practices include past and/or present knowledge of typical receipts; known layouts, forms, abbreviations, short-forms, characters and symbols used in receipts; and known configurations, practices, industry standards, and/or merchant-specific practices previously and/or currently used by merchants in their receipts.

Example embodiments are operable to analyze 320C extracted characters by referencing information, such as those described above, stored in one or more integrated 100, connected and/or remote storage media 180, 280, or the like. The one or more storage media may reside locally on the consumer computing device 100 and/or remotely on a network-accessible computing device 180, 280, including those for use in cloud computing. The one or more storage media may include static and/or dynamic databases, or the like. In respect to dynamic databases, it is to be understood herein that example embodiments may be operable to, either dynamically, continuously, intermittently and/or upon request, perform the functions of creating, amending, appending and/or deleting knowledge contained in the one or more databases. Example embodiments are operable to do so based on one or more statistical interpretations, consumer interactions, administrator interactions, and/or scheduled, user-initiated or dynamic searches on the internet, or the like.

4. Categorizing.

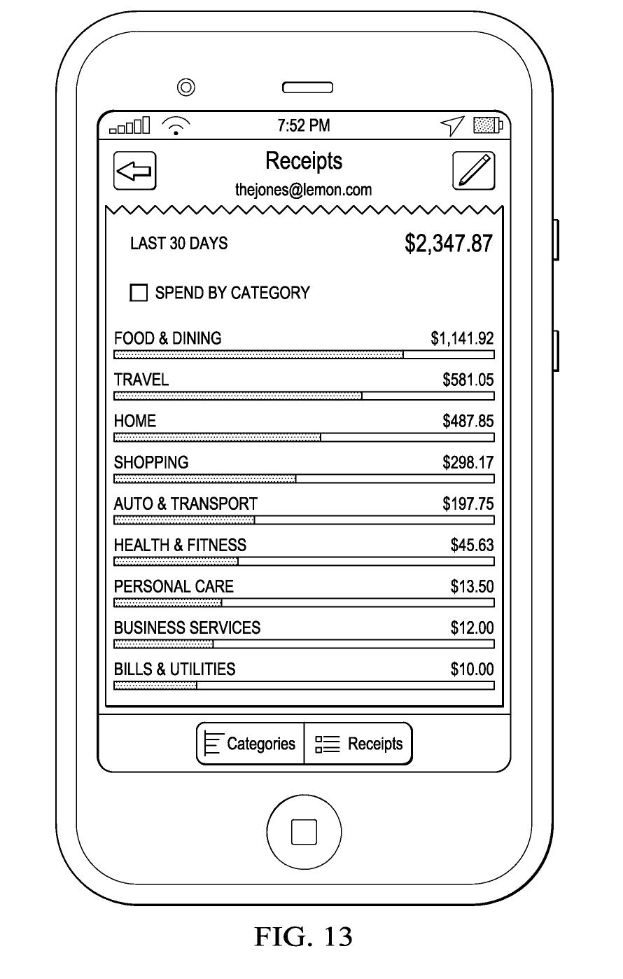

Example embodiments of consumer computing devices 100 and/or administrator network-accessible computing devices 180, 280 are operable to perform and/or facilitate performing the categorizing 320B of the captured, extracted and/or analyzed characters of each receipt. Categorizing 320B is performable in view of a plurality of considerations and into a plurality of categories. In an example embodiment, the characters are managed into one or more of the following categories: consumer; merchant categories and merchant information, such as merchant name, address, telephone number, website and/or email address; consumer-specific information, such as credit card accounts, debit card/bank accounts, loyalty accounts, merchants, ID, business cards, etc.; date and time of purchase; date and time of receipt; date and time of delivery; identification numbers, such as receipt numbers, order number, and other referencable numbers; QR codes, bar codes or other computer-recognizable codes; suggested and user-generated labels and notes; line item descriptions; line item quantities; line item amounts; total taxes paid; taxes paid per line item; pre-tax total amount; post-tax total amount; cash-equivalent and/or non-cash equivalent payment, including non-spending line items or transactions (ex. cashback); specific method(s) of payment (cash, credit, gift card, reward points, airmiles, etc.); partial or full payment; etc. FIG. 13 illustrates an example simplified view of a screen shot displayed on a consumer computing device summarizing example transactions within a specified period.

In example embodiments, consumer-specific information, such as credit card accounts, bank accounts, loyalty accounts, etc., may be securely accessed (ex. on demand, scheduled, etc.) by example embodiments so as to, among other things, compare and verify transactions, discover uncaptured transactions, reverse or cancel transactions, affect transactions (ex. purchase transaction, as described above), etc. In example embodiments, the accessing of consumer accounts described herein may be performable during capturing 310, analyzing 320C, and/or categorizing 320B, and may also be performable at any other time, such as scheduled or unscheduled times wherein the transaction management system may not be performing capturing, analyzing, categorizing, and/or advising/suggesting.

It is to be understood herein that the characters may be storable on one or more connected 100 and/or remote storage media 180, 280, or the like. The one or more storage media may reside locally on the consumer device 100 and/or remotely on a network-accessible computing device 180, 280, including those for use in cloud computing.

It is also to be understood herein that example embodiments are operable to combine or divide the operations of capturing 310, extracting 320A, analyzing 320C, categorizing 320B, reporting 330, and/or advising/suggesting 340, 350 into one or more operations. For example, the operations of capturing 310 and extracting 320A may be combinable as one operation in example embodiments.

Example embodiments operable to perform transaction management, including capturing 310, extracting 320A, analyzing 320C, categorizing 320B, and/or advising/suggesting 340, 350, are capable of overcoming the problems and inaccuracies found in conventional methods. In particular, example embodiments enable consumers to realize more accurate representations of their net cash-equivalent and non-cash equivalent transactions. Solutions to conventional problems and inaccuracies are best illustrated by way of examples. In the following examples, it is to be understood that the consumer has captured and/or stored one or more consumer-specific information (an example is depicted in FIG. 9), such as through use of the method illustrated in the example screen shot depicted in FIG. 10, and properly associated secure online login information for the information/accounts so as to enable example embodiments to securely access the information/accounts. It is also to be understood that the consumer, at any time, may also capture and store other consumer-specific information, including associated secure online login information. It should be noted that example embodiments may be operable to perform transaction management with or without capturing and/or storing consumer-specific information/accounts, and with or without accessing consumer-specific information/accounts through secure online login.

### EXAMPLE 1

In an example transaction, a single paper receipt 120 is issued to a consumer representing payment for items using only cash-equivalents, such as cash. A digital representation of the receipt 120 is capturable 310 using example embodiments of the consumer computing device. The consumer computing device may be a smart phone, a tablet, or the like, having instructions contained in the form of a mobile application for performing and/or facilitating with one or more administrator computing devices in performing example embodiments of the above-described process. Once captured 310, example embodiments are operable to provide the digital representation for further operations 320, 330, 340, 350, 360. One or more of these operations may be performed solely by the consumer computing device or the administrator computing device, or jointly by both the consumer computing device and the administrator computing device. In an example embodiment for use in cloud computing, the majority or all of the operations may be performable by the administrator computing device. The digital representation may also be available to the consumer for future reference. Storing of the information may be performable locally on the consumer computing device 100 and/or remotely on the administrator computing device 180, 280. Example embodiments of the administrator computing device are then operable to perform extracting 320A of characters from the digital representation, and analyzing 320C and categorizing 320B of the extracted characters.

Example embodiments of the administrator computing device are operable to analyze the extracted characters using a plurality of considerations, including how the extracted characters relate to other characters extracted from the receipt, knowledge of past and/or present merchant practices (such as keywords, short forms, symbols, etc.), consumer input (such as labels, whether the receipt was partially paid by the consumer, etc.), and/or administrator input. Example embodiments of the administrator computing device are then operable to categorize 320B the extracted information. Categories for this particular example receipt may include: identification that the transaction was a cash-equivalent transaction paid using only cash; merchant categories and/or information (name, address, telephone number, website and/or email address); date/time of purchase; receipt and/or order number; line item descriptions/quantities/amounts/taxes (which may be used along with other categories to further categorize spending, such as “dinner,” “clothing” or “business travel,” and generating reports such as determining whether the transaction may be eligible for business reimbursements and/or taxable reductions); taxes paid; and limitation on when a refund/exchange can be performed on the purchase.

In example embodiments, one or more certain categories (such as merchant information, date/time, receipt number, and line item information) may be used to further categorize, report and advise the consumer computing device of: past and future savings relevant to that particular consumer based on previously processed transactions; potentially reimbursable expenses; potential taxable reductions; properly managing subsequent refund/exchange transactions; and properly managing potentially duplicate transactions. For example, the administrator computing device will continuously and/or periodically perform searches (for a certain period, such as up to the expiry of an identified or typical refund/exchange period) of already purchased line items, such as using the internet, for better deals and/or coupons from the merchant or other merchants. In doing so, example embodiments may also determine whether the merchant or other merchants are offering other incentives, such as free shipping, reward points or miles, etc. Example embodiments may also analyze line items using consumer-provided personal information, such as the users occupation, to determine whether the line items may be eligible for reimbursements, taxable reductions, VAT refunds (for items purchased in foreign countries), and the like. Example embodiments may also analyze subsequent refund, exchange and/or delivery receipts using previously processed transactions, such as identification numbers (receipt/order numbers), date/time of purchase, line item descriptions, etc., so as to properly manage transactions and eliminate duplicate and/or corrected transactions.

In example embodiments, the administrator computing device is then operable to communicate with the mobile application contained in the consumer computing device to generate one or more default, suggested and/or consumer-customizable reports, alerts, notifications, and/or messages. Reports, alerts, notifications and messages may include those for only one particular receipt, or other forms of reports (to be further explained later).

### EXAMPLE 2

In an example transaction, a single email receipt 140 is received in a dedicated email account representing payment by the consumer using only cash-equivalents, such as a credit card. The consumer may forward the email receipt from the consumer computing device to a dedicated email address provided by the administrator, or the merchant may have sent the email receipt directly to the dedicated email address provided by the administrator. A digital representation of the email receipt 140 is capturable 310 by example embodiments of the administrator computing device operable to receive and manage email receipts and/or electronic receipt attachment(s) 140. The consumer computing device may be a smart phone, a tablet, or the like, having instructions contained in the form of a mobile application for performing and/or facilitating with one or more administrator computing devices in performing example embodiments of the above-described process. Once captured 310, example embodiments are operable to perform further operations 320, 330, 340, 350, 360 on the digital representation. One or more of these operations may be performed solely by the consumer computing device or the administrator computing device, or jointly by both the consumer computing device and the administrator computing device. In an example embodiment for use in cloud computing, the majority or all of the operations may be performable by the administrator computing device. The digital representation may also be available to the consumer for future reference. Storing of the information may be performable locally on the consumer computing device 100 and/or remotely on the administrator computing device 180, 280. Example embodiments of the administrator computing device are then operable to perform extracting 320A of characters from the digital representation, and analyzing 320C and categorizing 320B of the extracted characters in a similar manner as described above, including those described in Example 1. It is to be understood herein that example embodiments are operable to capture, extract, analyze and appropriately categorize the transactions contained in a receipt to a specific account of the consumer. In this particular example, the credit card number on the receipt will enable example embodiments to appropriately manage the transaction as belonging to a consumer's particular credit card account. In other examples, if the particular credit card has not yet been stored by the consumer, example embodiments will enable the consumer to create a new stored account. In this respect, if the consumer does not wish to create a new account at the time of capture, example embodiments are operable to create a temporary account with the captured information from the receipt.

### EXAMPLE 3

In an example transaction, a consumer is not in possession of a receipt for a transaction paid using only cash-equivalents, such as a credit card. A digital representation of the transaction is capturable from a voice receipt 150 recorded by the consumer 100 and/or merchant 110. The consumer computing device may be a smart phone, a tablet, or the like, having instructions contained in the form of a mobile application for performing and/or facilitating with one or more administrator computing devices in performing example embodiments of the above-described process. Once captured 310, example embodiments are operable to perform further operations 320, 330, 340, 350, 360 on the digital representation, including extracting 320A of characters from the digital representation using, for example, speech recognition and parsing instructions contained in example embodiments. One or more of these operations may be performed solely by the consumer computing device or the administrator computing device, or jointly by both the consumer computing device and the administrator computing device. In an example embodiment for use in cloud computing, the majority or all of the operations may be performable by the administrator computing device. The digital representation may also be available to the consumer for future reference. Storing of the information may be performable locally on the consumer computing device 100 and/or remotely on the administrator computing device 180, 280. Example embodiments of the administrator computing device are then operable to perform extracting 320A of characters from the digital representation, and analyzing 320C and categorizing 320B of the extracted characters in a similar manner as described above, including those described in Examples 1 and 2. It is to be understood that the voice receipt may include a pre-assigned label or name for the credit card, which will enable convenient and accurate recording of the voice receipt to the appropriate consumer account without requiring the user to record the entire credit card number.

### EXAMPLE 4

In an example transaction, an email receipt 140 is issued to a consumer representing payment of an item purchased from an online merchant using only cash-equivalents, such as a credit card. A paper receipt 120 is subsequently issued for the same internet purchase, which is provided to the consumer in the delivery of the purchased item.

In respect to the email receipt 140, a digital representation is captured 310, extracted 320A, analyzed 320C and categorized 320B in an equivalent manner as Example 2. In respect to the paper receipt 120, which is typically received by the consumer several days or weeks after the email receipt 140 is received, a digital representation of the receipt 120 is captured 310, extracted 320A, analyzed 320C and categorized 320B in a similar manner as described above, including those described in Examples 1-3.

In the latter analyzing 320C and categorizing 320B operations for the paper receipt 120, example embodiments are operable to compare the information with a plurality of previously stored transactions by the consumer. In doing so, example embodiments are operable to identify and alert the consumer of a potentially conflicting (duplicate) transaction, thereby improving the accuracy of subsequent reporting operations. It is to be understood herein that example embodiments are operable to identify and alert consumers of potentially conflicting (duplicate) transactions in other situations. Example situations include those wherein an email receipt 140 is issued to the consumer after the paper receipt 120; a voice receipt 150 for the same transaction is recorded by the consumer in addition to or in replacement of one or more of the email receipt 140 and paper receipt 120; the receipts are all of one type of receipt (such as paper receipts); an earlier received receipt is recorded by the consumer after recording a later received receipt; and the like. The consumer may also be provided with advice 340, 350 on savings for past and/or future transactions based on one or more processed digital representations.

### EXAMPLE 5

In an example transaction, a single paper receipt 120 is issued to a consumer representing credit card payment for the purchase of an item and a cashback transaction. A digital representation of the receipt 120 is capturable 310 in an equivalent manner as Example 1. Once captured 310, example embodiments are operable to provide the digital representation for further operations 310, 320, 330, 340, 350, 360 and future reference in a similar manner as described above, including those described in Examples 1-4. Storing of the information may be performed locally 100 and/or remotely 180, 280 in an equivalent manner as Example 1. Example embodiments are then operable to perform extracting 320A, analyzing 320C and categorizing 320B in an equivalent manner as Example 1. In this regard, example embodiments are operable to, among other things, categorize 320B the item purchase transaction as a cash-equivalent expenditure and the cashback transaction as a non-cash equivalent expenditure. Cashback transactions are identifiable in example embodiments in a plurality of ways, such as by parsing and identifying the line item description of the cashback transaction. Identification and/or confirmation of a cashback transaction may also be achievable in other ways, such as by performing an analysis of the total amount of taxes paid with reference to one or more line item amounts. Example embodiments then make the categorized 320B information of the item purchase transaction and the cashback transaction available for reporting 330. The consumer may also be provided with advice 340, 350 on savings for past and/or future transactions based on one or more processed digital representations.

### EXAMPLE 6

In an example transaction, a paper receipt 120 is issued to a consumer representing payment of an item purchased using only cash-equivalents, such as cash. At a later date/time, a paper refund receipt 120 is subsequently issued for refunding the previously purchased item.

In respect to the first paper receipt 120, a digital representation of the receipt is captured 310, extracted 320A, analyzed 320C and categorized 320B in an equivalent manner as Example 1. In respect to the later paper refund receipt 120, a digital representation is also captured 310, extracted 320A, analyzed 320C and categorized 320B in an equivalent manner as Example 1.

In the latter analyzing 320C and categorizing 320B operations for the paper refund receipt 120, example embodiments are operable to identify and categorize 320B the transaction as a refund transaction based on, among other things, express identification of the refund transaction in one or more line items and/or areas of the receipt 120. Example embodiments are then operable to compare the refund information with a plurality of previously stored purchase transactions and receipts by the consumer. In doing so, example embodiments are operable to identify and group the corresponding transaction and receipt for reporting 330 to the consumer and allow accurate representation of net cash-equivalent expenditures. In this regard, the accuracy of subsequent reporting operations 330 are improved. It is to be understood herein that example embodiments are operable in other situations, including partial refunds of some, but not all, items in a receipt 120, 130, 140, 150. Example embodiments are also operable to identify receipts 120, 130, 140, 150 for exchanges, including those which result in partial refunds (the replacement transaction cost is less than the original transaction) and/or those requiring additional payment (the replacement transaction cost is more than the original transaction). The consumer may also be provided with advice 340, 350 on savings for past and/or future transactions based on one or more processed digital representations. Example embodiments are also operable to create and properly account for one or more missing purchase receipts, such as in situations wherein a receipt for a purchase transaction was never processed but a receipt for refunding that purchase transaction was processed.

### EXAMPLE 7

In an example transaction, a single paper receipt 120 is issued to a consumer representing payment using foreign currency cash-equivalents, such as Canadian Dollars. A digital representation of the receipt 120 is capturable 310 using example embodiments comprising an integrated digital camera 103 in an equivalent manner as Example 1. Once captured 310, example embodiments are operable to provide the digital representation for further operations 320, 330, 340, 350, 360 in an equivalent manner as Example 1. Storing of the information may be performable locally 100 and/or remotely 180, 280 in an equivalent manner as Example 1. Example embodiments are then operable to perform extracting 320A of meaningful characters from the digital representation, which may include first identifying the language (For example, Canadian English and/or French) of the characters and/or merchant address, telephone number, website and/or email address. Example embodiments are then operable to analyze 320C and categorize 320B the characters in an equivalent manner as Example 1. In this regard, example embodiments are operable to, among other things, determine which currency and/or language is contained in the receipt. This operation may be necessary for some receipts, particularly in situations wherein a foreign transaction was conducted using another currency, such as a U.S. Dollar transaction at a duty free store. If it is determined that the currency is one other than the default or preferred currency of the consumer, example embodiments are operable to perform a search, such as using the internet 107 or the like, to determine the exchange rate as of the date of the receipt (including date/time difference considerations). Example embodiments may also enable the consumer to provide 102, 107 a preferred exchange rate and/or use the consumers credit card company rates. Once obtained, the foreign currency amount is convertible to the default currency of the consumer, which enables a more accurate representation of net cash-equivalent expenditures. Example embodiments then make the categorized 320B information of the foreign currency transaction available for reporting 330. The consumer may also be provided with advice 340, 350 on savings for past and/or future transactions based on one or more processed digital representations.

### EXAMPLE 8

In an example transaction, a single paper receipt 120 is issued to a consumer representing non-cash equivalent payment for the purchase of an item using consumer-accumulated loyalty or reward points. A digital representation of the receipt 120 is capturable 310 in an equivalent manner as Example 1. Once captured 310, example embodiments are operable to provide the digital representation for further operations 320, 330, 340, 350, 360 and future reference in an equivalent manner as Example 1. Storing of the information may be performed locally 100 and/or remotely 180, 280 in a similar manner as described above, including those in the above examples. Example embodiments are then operable to perform extracting 320A, analyzing 320C and categorizing 320B in an equivalent manner as Example 1. In this regard, example embodiments are operable to, among other things, categorize 320B the item purchase transaction as a non-cash equivalent expenditure using loyalty or reward points. Non-cash equivalent transactions, such as those using reward points, air miles, or the like, are identifiable in example embodiments in a plurality of ways, such as by parsing and identifying one or more pieces of information contained in the receipt 120, 130, 140, 150, such as express language and/or taxes paid. Identification and/or confirmation of a non-cash equivalent transaction may also be achievable in other ways, such as by comparing information provided by the consumer pertaining to specific loyalty or reward programs held (captured and saved) by the consumer. Example embodiments are also operable to keep track of consumer balances of non-cash equivalents, such as loyalty or reward points, air miles, or the like. Example embodiments then make the categorized 320B information of the non-cash equivalent transaction available for reporting 330. The consumer may also be provided with advice 340, 350 on savings for past and/or future transactions based on one or more processed digital representations.

### EXAMPLE 9

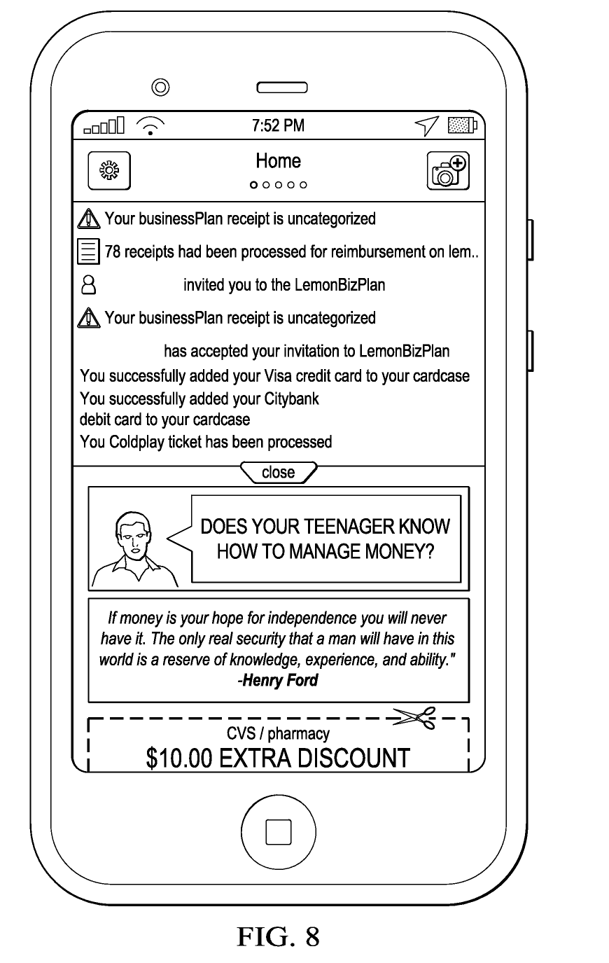

In an example embodiment, a home page (an example is illustrated in FIGS. 7 and 8) displayed on a consumer computing device is provided with one or more suggestions of products and/or services based on assessments of, among other things, consumers spending habits, preferred merchants, price ranges, historic dates/occasions of transactions, etc. Example embodiments are operable to enable the consumer to view the advice/suggestion, such as by using a mouse or a touch-screen. Example embodiments are operable to display details of the product and/or service, such as on a separate page, expanding the current page, providing audio/video descriptions, and/or through launching an internet browser, and operable to provide the consumer with options to affect a transaction for the products and/or services. In this regard, the consumer may be provided with an option to quickly and securely purchase the products and/or services using one or more consumer accounts, such as a Visa credit card, a gift card, and/or a credit note, by simply selecting the desired consumer account(s) and not having to manually enter specific information of the credit card, such as the cardholder's name, credit card number, expiry date, CSV number, billing address, shipping address, etc. Example embodiments also enable the consumer to perform a one-time capture of a consumer-specific account, such as a Visa card, to complete the transaction. It is to be understood that the consumer may be prompted to confirm the purchase, enter a security code prior to completing the transaction, and/or confirm the identity of the consumer (such as through use of captured consumer information, such as a drivers license card). After completing the transaction, example embodiments are operable to perform capturing, extracting, analyzing, categorizing, reporting, and/or advising/suggesting of the transaction in a similar manner as described herein, including those described in the above examples.

### EXAMPLE 10

In an example embodiment, a consumer may launch an internet browser from the home page (an example is illustrated in FIGS. 7 and 8) of the consumer computing device so as to enable the consumer to perform, among other things, online shopping. Example embodiments are operable to enable the consumer to quickly complete an online shopping transaction in a similar manner as described above in Example 9. After completing the transaction, example embodiments are operable to perform capturing, extracting, analyzing, categorizing and/or reporting of the transaction in a similar manner as described herein, including those described in the above examples.

5. Reporting.

Example embodiments of consumer computing devices 100 and/or administrator network-accessible computing devices 180, 280 are operable to perform and/or facilitate performing the generating of a plurality of different types of reports 330 based on one or more processed transactions. Reports 330 may be generated either continuously (ex. streaming), intermittently, and/or generated upon consumer request.

In an example embodiment, information that has been analyzed 320C and categorized 320B by one or more administrator computing devices 180, 280 may be automatically provided to the consumer computing device 100 for use in rendering a displayable report 330. For example, the categorized 320B information may be automatically provided (by default) based on cash-equivalent transactions within a certain time frame, such as the past month. In an example embodiment, information that has been analyzed 320C and categorized 320B by one or more administrator computing devices 180, 280 may be selectively provided to the consumer computing device 100 for use in generating a displayable customized report 330. For example, the categorized 320B information may be selectively provided (by consumer selection) based on cash-equivalent transactions for one or more particular merchants 110 within a certain time frame, such as the past two weeks. The categorized information 320B may be further refined so as to include consumer-specific account information, such as specific credit card accounts, debit card/bank accounts, loyalty accounts, etc. As another example, the categorized 320B information may be based on non-cash equivalent transactions, such as those wherein a refund was obtained. In such an example, both the purchase transaction and the refund transaction may be displayable on the consumer computing device 100.

In example embodiments, reports 330 may be customizably generated by sorting and/or filtering one or a plurality of categories 320B, as well as securely accessing consumer-specific online accounts. For example, reports may be generated based on date and/or time of the transactions. Reports may also be generated based on the merchant category and/or information, industry, geographical location and/or currency. Reports may also be generated based on default, suggested, and/or user-defined labels and notes, which may be appended to transactions. Reports may also be generated based on cash-equivalent purchases, non-cash equivalent purchases, cash-only purchases, credit-only purchases, layaway purchases, and non-spending transactions, such as cashback transactions. Reports may also be generated based on transactions for specific consumer accounts, such as specific credit card accounts, debit card/bank accounts, loyalty accounts, etc. Reports may also be generated based on those that were refunded, exchanged, or corrected. Reports may also be generated based on whether the transaction was a business or personal transaction. Reports may also be generated based on those transactions wherein the consumer made partial contributions to the transaction. Reports may also be generated for potentially conflicting transactions, such as redundant purchases, unclear purchases, refunded or exchanged purchases, possible foreign currency purchases and languages, and/or possible non-cash equivalent purchases. Furthermore, reports may be generated to provide advice on available savings for previous transactions. In this regard, example embodiments are operable to assess and advise on one or more processed transactions and perform searches, such as on the internet, for better deals (lower prices) and/or available coupons, etc. Reports may also be generated to provide advice on potential savings for future transactions. In this regard, example embodiments are operable to assess and advise on one or more processed transactions and perform searches, such as on the internet, for goods and/or services that may interest the consumer, including providing price alerts, deals and reviews. Reports may then be generated to enable administrators to, among other things, review and analyze transactions which were suggested to the consumer that were actually purchased by the consumer. This enables the administrator to, among other things, better understand the accuracy and effectiveness of the suggested or advised products and/or services. Reports may also be generated for potential tax-deductible transactions, which may be identifiable in example embodiments upon receiving consumer-specific information such as occupation, geographical location, etc.

Example embodiments of the consumer computing device 100 may comprise a display 101, an attached or integrated capturing device 103, an attached or integrated memory storage medium (not shown), and a processor (not shown). In some embodiments, the processor may be operable to perform one or more of the above process operations of capturing 310, extracting 320A, analyzing 320C, categorizing 320B, reporting 330 and advising 340, 350. In some embodiments, the processor is operable to enable the consumer computing device 100 to communicate with one or more administrator network-accessible computing devices 180, 280 so as to facilitate the one or more administrator network-accessible computing devices 180, 280 to perform one or more of the above process operations of capturing 310, extracting 320A, analyzing 320C, categorizing 320B, reporting 330 and advising 340, 350.

Example embodiments of the administrator network-accessible computing device 180, 280 may comprise or be in communication with an integrated administrator capturing device, an administrator memory storage medium (such as a database for use in cloud computing), and an administrator processor. In some example embodiments, the administrator processor is operable to perform one or more of the above process operations of capturing 310, extracting 320A, analyzing 320C, categorizing 320B, reporting 330 and advising 340, 350. In some embodiments, the administrator processor is operable to communicate with the consumer computing device 100 so as to facilitate the consumer computing device 100 to perform one or more of the above process operations of capturing 310, extracting 320A, analyzing 320C, categorizing 320B, reporting 330 and advising 340, 350. In some example embodiments, the administrator capturing device 180, 280 comprises an electronic message server, such as an email server or the like, for receiving and processing forwarded consumer emails and dedicated consumer emails. It is to be understood that, in enabling the consumer to perform the various example embodiments of the above-described transaction management, the administrator(s) are provided with information pertaining to, among other things, consumer-specific transactions (spending, returns, discounts, interests, savings, etc.), accuracy and effectiveness of advice and suggestions on products and/or services based on the captured consumer-specific transactions, etc.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, as referred to herein, a computing device, communication device, or capturing device may be a virtual machine, computer, node, instance, host, or machine in a networked computing environment. Also as referred to herein, a network or cloud may be a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A network or cloud may include, but is not limited to, computing grid systems, distributed computing environments, cloud computing environment, etc. Such network or cloud includes hardware and software infrastructures configured to form a virtual organization comprised of multiple resources which may be in geographically disperse locations.

Although various computer elements, communication devices and capturing devices have been illustrated herein as single device or machine, such elements may operate over several different physical machines, or they may be combined as operating code instances running on a single physical machine. The claims in the present application comprehend such variation in physical machine configurations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A computing device operable to perform transaction management of a plurality of transaction receipts, said computing device operable to communicate with at least one network-accessible computing device and comprising:
a display screen;
a capturing device operable to capture a digital representation of at least a part of a transaction receipt;
a storage medium operable to store digital representations captured by the capturing device; and
a processor operable to:
communicate with the capturing device to perform capturing of the digital representation;
communicate with the storage medium to store the captured digital representation;
communicate with at least one network-accessible computing device to facilitate processing of the digital representation; and
communicate with the display screen to display at least one cash-equivalent transaction report of one or more processed digital representations.

2. The computing device of claim 1, wherein the processing of digital representations comprises storing of the digital representation, extracting of information from the digital representation, and analyzing and categorizing of the extracted information from the digital representation.

3. The computing device of claim 2, wherein the processor is operable to selectively receive one or more categorized information of one or more processed digital representations for use in displaying cash-equivalent transaction reports.

4. The computing device of claim 3, wherein the processor is further operable to selectively receive one or more categorized information of one or more processed digital representations for use in displaying non-cash equivalent transaction reports.

5. The computing device of claim 3 or 4, wherein the processor selectively receives the categorized information based on at least one user-defined criterion.

6. The computing device of claim 1, wherein the processor is further operable to display advice on past and future savings based on one or more processed digital representations.

7. The computing device of claim 1, wherein the at least one network-accessible computing devices facilitates processing of digital representations by way of cloud computing.

8. The computing device of claim 1, wherein the capturing device is further operable to store a digital representation of at least one consumer-specific account.

9. The computing device of claim 8, wherein the consumer-specific account comprises one or more of credit card accounts, debit/bank accounts, and loyalty accounts.

10. The computing device of claim 1, wherein the capturing device is a digital camera.

11. The computing device of claim 1, wherein the capturing device is a microphone.

12. The computing device of claim 1, wherein the capturing device is a keyboard.

13. The computing device of claim 1, wherein the transaction receipt is a physical receipt.

14. The computing device of claim 1, wherein the transaction receipt is an electronic receipt.

15. The computing device of claim 1, wherein the transaction receipt is a voice receipt.

16. A computing device for transaction management of a plurality of transaction receipts, said computing device operable to communicate with at least one network-accessible computing device and operable to:
capture a digital representation of at least a part of a transaction receipt;
extract information from the captured digital representation;
analyze and categorize the extracted information; and
display at least one cash-equivalent transaction report based on one or more categorized information.

17. A network-accessible computing device operable to facilitate transaction management of a plurality of transaction receipts, said network-accessible computing device operable to communicate with a consumer computing device and comprising:
a capturing device operable to capture a digital representation of at least a part of a transaction receipt;
a storage medium operable to store digital representations captured by the capturing device; and
a processor operable to:
process the digital representation captured from the capturing device;
process a digital representation of a transaction captured from the consumer computing device; and
communicate with the consumer computing device to facilitate displaying of at least one cash-equivalent transaction report of one or more processed digital representations.

18. The network-accessible computing device of claim 14, wherein the processing of digital representations comprises extracting of information from the digital representation, and analyzing and categorizing of the extracted information from the digital representation.

19. The network-accessible computing device of claim 15, wherein the processor is operable to selectively communicate one or more categorized information of one or more processed digital representations to the consumer computing device for use in displaying a cash-equivalent transaction report.

20. The network-accessible computing device of claim 16, wherein the processor is further operable to selectively communicate one or more categorized information of one or more processed digital representations to the consumer computing device for use in displaying non-cash equivalent transaction reports.

21. The network-accessible computing device of claim 16 or 17, wherein the processor selectively communicates the categorized information based on at least one user-defined criterion.

22. The network-accessible computing device of claim 14, wherein the processor is further operable to communicate advice on past and future savings to the consumer computing device based on one or more processed digital representations.

23. The network-accessible computing device of claim 14, wherein the processor facilitates processing of digital representations by way of cloud computing.

24. The network-accessible computing device of claim 14, wherein the transaction receipt is an electronic receipt.

25. The network-accessible computing device of claim 21, wherein the electronic receipt is an email receipt.

26. A network-accessible computing device for transaction management of a plurality of transaction receipts, said network-accessible computing device operable to communicate with a consumer computing device and operable to:
capture a digital representation of at least a part of a transaction receipt;
extract information from the captured digital representation;
analyze and categorize the extracted information; and
selectively communicate one or more categorized information of one or more processed digital representations to the consumer computing device for use in displaying cash-equivalent transaction reports.

27. A system operable to perform transaction management of a plurality of transaction receipts, said system comprising:
a consumer computing device comprising:
a consumer display screen;
a consumer capturing device operable to capture a digital representation of at least a part of a transaction receipt;
a consumer storage medium operable to store digital representations captured by the consumer capturing device; and
a consumer processor operable to communicate with the consumer capturing device to perform capturing of the digital representation; communicate with the consumer storage medium to store captured digital representations; facilitate processing of the digital representation; and communicate with the consumer display screen to display at least one cash-equivalent transaction report of one or more processed digital representations; and
an administrator computing device comprising:
an administrator capturing device operable to capture a digital representation of at least a part of an electronic transaction receipt;
an administrator storage medium operable to store digital representations captured by the administrator capturing device and digital representations captured by the consumer capturing device; and
an administrator processor operable to process one or more digital representations of one or more transactions captured from the administrator capturing device and the consumer capturing device; and communicate with the consumer computing device to facilitate displaying of at least one cash-equivalent transaction report of one or more processed digital representations;
wherein the consumer computing device facilitates processing and the administrator computing device processes one or more digital representations captured by the consumer capturing device when the consumer computing device communicates the digital representation to the administrator computing device.

28. The system of claim 24, wherein the processing of digital representations by the administrator computing device comprises storing the digital representation, extracting information from the digital representation, and analyzing and categorizing the extracted information from the digital representation.

29. The system of claim 25, wherein the consumer processor is operable to selectively receive one or more categorized information of one or more processed digital representations for use in displaying cash-equivalent transaction reports.

30. The system of claim 26, wherein the consumer processor is further operable to selectively receive one or more categorized information of one or more processed digital representations for use in displaying non-cash equivalent transaction reports.

31. The system of claim 26 or 27, wherein the consumer processor selectively receives the categorized information based on at least one user-defined criterion provided to the administrator processor.

32. The system of claim 24, wherein the consumer processor is further operable to communicate with the consumer display screen to display advice on past and future savings based on one or more processed digital representations.

33. The system of claim 24, wherein the administrator computing device processes the digital representations by way of cloud computing.

34. The system of claim 24, wherein the consumer capturing device is further operable to store a digital representation of at least one consumer-specific account.

35. The system of claim 25, wherein the consumer-specific account comprises one or more of credit card accounts, debit/bank accounts, and loyalty accounts.

31. The system of claim 24, wherein the consumer capturing device is a digital camera.

32. The system of claim 24, wherein the consumer capturing device is a microphone.

33. The system of claim 24, wherein the administrator capturing device is an electronic message server.

34. The system of claim 24, wherein the transaction receipt is a physical receipt.

35. The system of claim 24, wherein the transaction receipt is an electronic receipt.

36. The system of claim 24, wherein the transaction receipt is a voice receipt.
